(19) United States
(12) Patent Application Publication
(10) Pub. No.: US 2011/0084629 A1
(43) Pub. Date: Apr. 14, 2011

(54) LED LIGHTING DEVICE

(75) Inventor: Carlo Pini, Castiglione Delle Stiviere (IT)

(73) Assignee: NADLEC S.R.L., CASTEL GOFFREDO (MANTOVA) (IT)

(21) Appl. No.: 12/995,941

(22) PCT Filed: Oct. 29, 2008
(86) PCT No.: PCT/IB2008/054463

§ 371 Date: Dec. 2, 2010

(30) Foreign Application Priority Data
Jun. 6, 2008 (IT) PR2008A000038

(51) Int. Cl. H05B 37/02; F21V 11/00; F21V 9/00

(52) U.S. Cl. 315/312; 362/235

(57) ABSTRACT

LED lighting device (1) comprising a plurality of LED light sources (3) positioned on a support surface (2) and a plurality of optical elements (4) coaxial to the light sources (3) to generate collimated light beams (5), the light sources (3) being individually inclined relative to a predefined plane (6) to form angles, also different, in such a way that collimated light beams (5) intersect defining convergence points.

### TECHNICAL FIELD AND BACKGROUND ART

The present invention relates to a LED lighting device. In particular, the device finds application in road lighting systems and in the civil lighting sector, both indoors and outdoors.

As is well known, several lighting devices exist on the market in which the LEDs, i.e. light-emitting diodes, are used in place of traditional light sources. Whilst until a few years ago LEDs emitted sufficient light to be used almost exclusively as indicators in electronic circuits, the advent of high efficiency LEDs has made it possible to extend their use also to more versatile lighting equipment as well. Indeed, high efficiency LEDs are devices capable of emitting (white or monochromatic) light with greater efficiency, and hence lower consumption, than incandescent or halogen lamps. Finally, LEDS allow to obtain higher uniformity and lighting efficiency.

In particular, the main advantages of the LED technology reside in the energy savings and in the lowering of light pollution. Moreover, LED devices have longer working lives and far shorter starting times than traditional lamps.

In particular, some Italian City Authorities have already provided public lighting systems employing LED technology. The lighting devices developed thus far comprise flat, curved or circular lighting bodies housing a plurality of LED light sources. Each lighting body, provided with a power supply for the LEDs, is mounted on a post to form a lamp-post able to illuminate a segment of road.

Known devices exhibit an evident disadvantage due to the limited ability to orient the generated light cone. Indeed, the LED light sources are mounted in the lighting body in such a way as to emit light beams substantially parallel or converging in a single axis to illuminate a portion of road of defined dimensions and positioned at a precise distance from the lamp-post itself. Clearly, to illuminate road segments at variable distances from the lamp-post, it is necessary to appropriately direct the lighting body. For instance, one can vary the inclination of the lighting body relative to the road surface, or increase its height to generate a light cone directed according to requirements.

However, even varying the inclination of the lighting body, a sufficiently homogeneous illumination is still not obtained, i.e. on the road surface it is often possible to distinguish the projections (commonly known as “spots”) of light beams originating from the LEDs.

An additional disadvantage of the prior art resides in high luminous dispersion, whereby only a percentage of emitted light (less than 65%) actually reaches and illuminates the predefined road segment.

### DISCLOSURE OF THE INVENTION

An object of the present invention is to eliminate the aforesaid drawbacks and to make available a LED lighting device in which the light cone generated is appropriately oriented to illuminate surfaces (e.g. road segments) positioned at different distances from the device itself. An additional object of the present invention is to propose a LED lighting device that enables to illuminate a predetermined surface homogeneously.

Another object of the present invention is to make available a LED lighting device that has high efficiency, minimising light dispersion.

Said objects are fully achieved by the LED lighting device of the present invention, which comprises the characteristics contained in claim 1 and in the subsequent claims.

### BRIEF DESCRIPTION OF DRAWINGS

These and other objects shall become more readily apparent from the following description of a preferred embodiment, illustrated purely by way of non limiting example in the accompanying drawing tables in which:

FIGS. 1 and 3 show respectively a perspective bottom view and a lateral view of a LED lighting device and the optical effect generated thereby, according to the present invention;

FIG. 2 shows a top perspective view of the device of FIG. 1;

FIGS. 4 and 5 show a bottom perspective view of the device of FIG. 1 (in which some parts have been removed for clarity);

FIG. 6 shows a bottom perspective view of the device of FIG. 1;

FIG. 7 shows a sectioned (bottom) perspective view of the device of FIG. 1;

FIG. 8 shows a partially sectioned (bottom) perspective view of the device of FIG. 1;

FIG. 9 shows a sectioned front view of the device of FIG. 1;

FIG. 10 shows a bottom view of the device of FIG. 1;

FIGS. 11 and 12 respectively show a top perspective view and a bottom view of a different embodiment of the device of FIG. 1;

FIG. 13 shows a top perspective view of a detail of the device of FIG. 11.

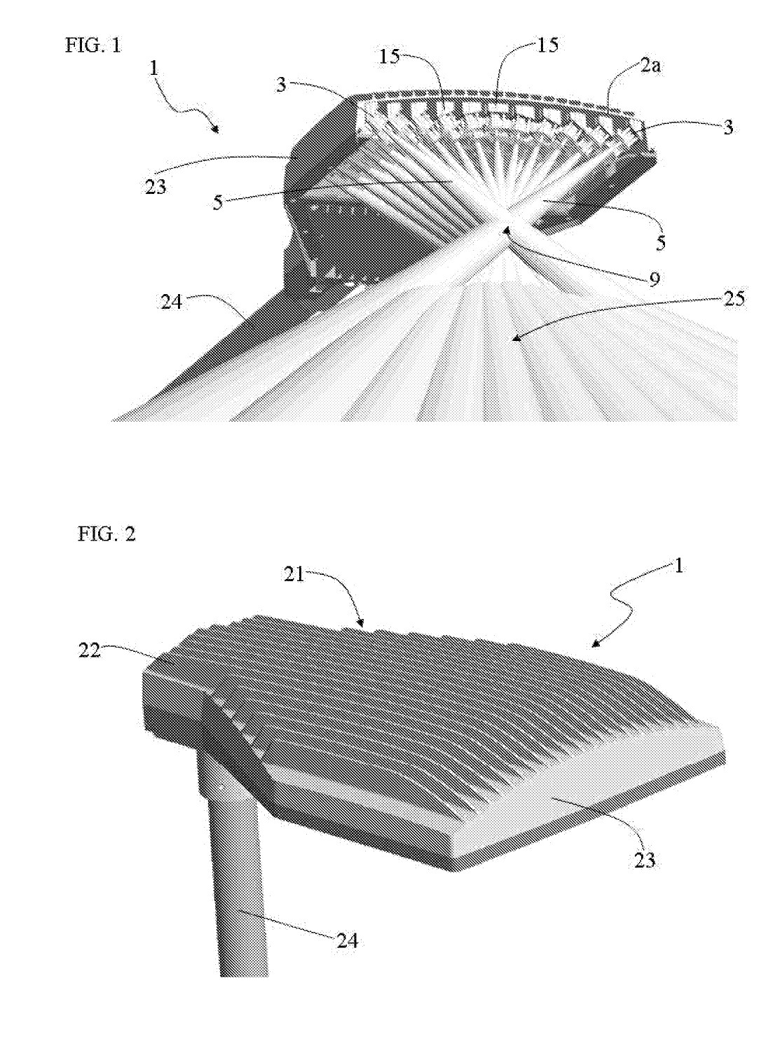

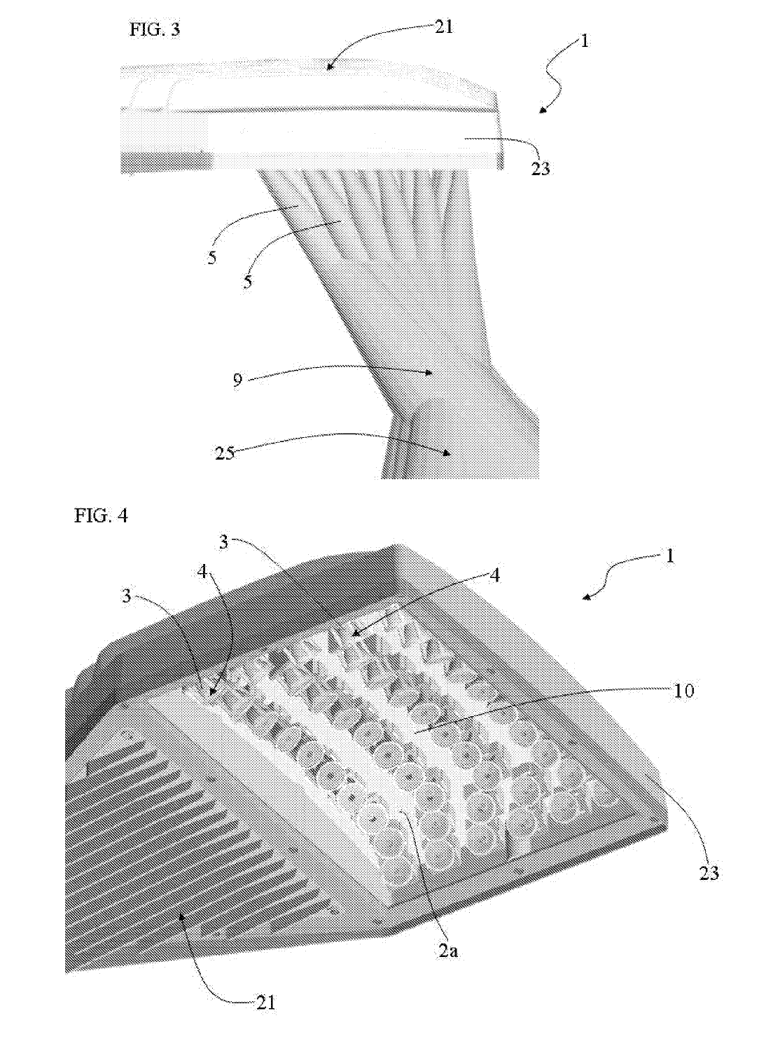

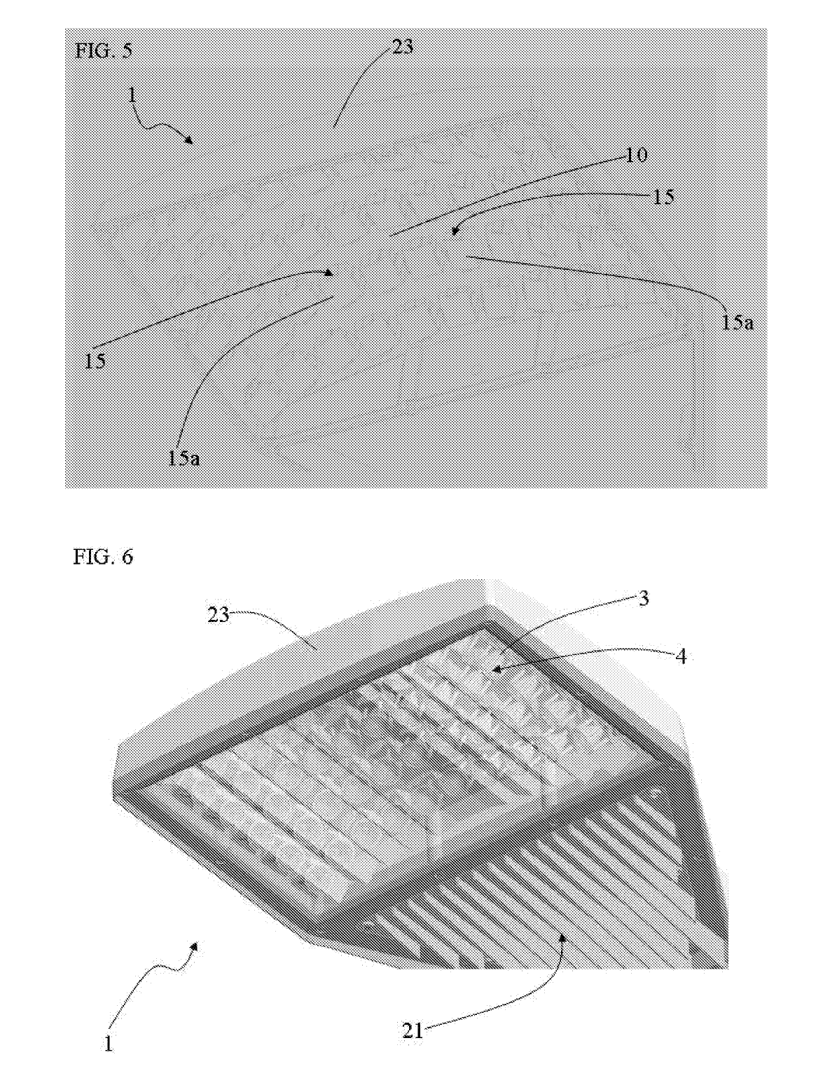

### BEST MODE FOR CARRYING OUT THE INVENTION

With reference to figures, number 1 indicates a LED lighting device, in particular for use in road lighting.

The device 1 comprises a support surface 2 and a plurality of LED light sources 3 positioned on the support surface 2. Preferably, all the light sources 3 are on a first side 2a of the support surface 2. Preferably, each of the light sources 3 is constituted by a monochromatic LED.

The device 1 is further provided with a plurality of optical elements 4 associated with the light sources 3 and coaxial thereto to generate collimated light beams 5. In this way, a multi-projection of collimated light beams 5 is created, able to cover a defined space to be illuminated. Preferably, the optical elements 4 are constituted by optical collimators that narrow the widths of the light beams emitted by the LED light sources 3. Indeed, the LED light sources 3 have directional opening generally between 90° and 120°, whilst the collimators reduce the opening range to about 6°-40°.

Originally, the light sources 3 are individually inclined relative to a predefined plane 6 to form angles, also different, in such a way that collimated light beams 5 intersect defining convergence points. Preferably, each light source 3 is inclined according to two directions relative to the predefined plane 6. Since the optical elements 4 are coaxial to the light sources 3, they are also inclined relative to the predefined plane 6.

Preferably, each optical element 4 is associated to one of the light sources 3 in such a way that the related collimated light beam 5 intersects at least another one of said collimated light beams 5. In particular, each optical element 4 is inclined relative to the predefined plane 6 by the same angle of inclination of the corresponding light source 3 whereto it is associated.

Advantageously, the convergence points of the collimated light beams 5 identify a smaller convergence area 9 than the area 10 delimited by the light sources 3 on the support surface 2. Preferably, the convergence points of the collimated light beams 5 define a convergence plane that is substantially parallel to the predefined plane 6. In this case, the convergence area 9 belongs to the convergence plane.

In a first embodiment, the support surface 2 is constituted by a portion 12 of a semi-cylindrical cladding. Said portion 12 is positioned in such a way as to have concavity 14 substantially tangential to the predefined plane 6. In this way, each light source 3 is inclined relative to the predefined plane 6 in a first direction of inclination parallel to the longitudinal extension of the portion 12 of the semi-cylindrical cladding. The device 1 is also provided with supports 15 for each of the light sources 3. Said supports 15 are mounted internally to the portion 12 of the semi-cylindrical cladding, i.e. on the first side 2a of the support surface 2. In this way, the convergence points of the collimated light beams 5 are opposite to the predefined plane 6 relative to the portion 12 of the semi-cylindrical cladding.

Preferably, in this first embodiment, each support 15 is provided with a base 15a whereon is mounted the corresponding light source 3. Preferably, the bases 15a have rectangular shape. All the bases 15a of the supports 15 have the same superficial extension but different inclination relative to the predefined plane 6. In particular, each light source 3, being mounted on the corresponding support 15, is inclined relative to the predefined plane 6 in a second direction of inclination different from the first direction of inclination. Each light source 3, therefore, is inclined relative to the predefined plane 6 according to two directions of inclination.

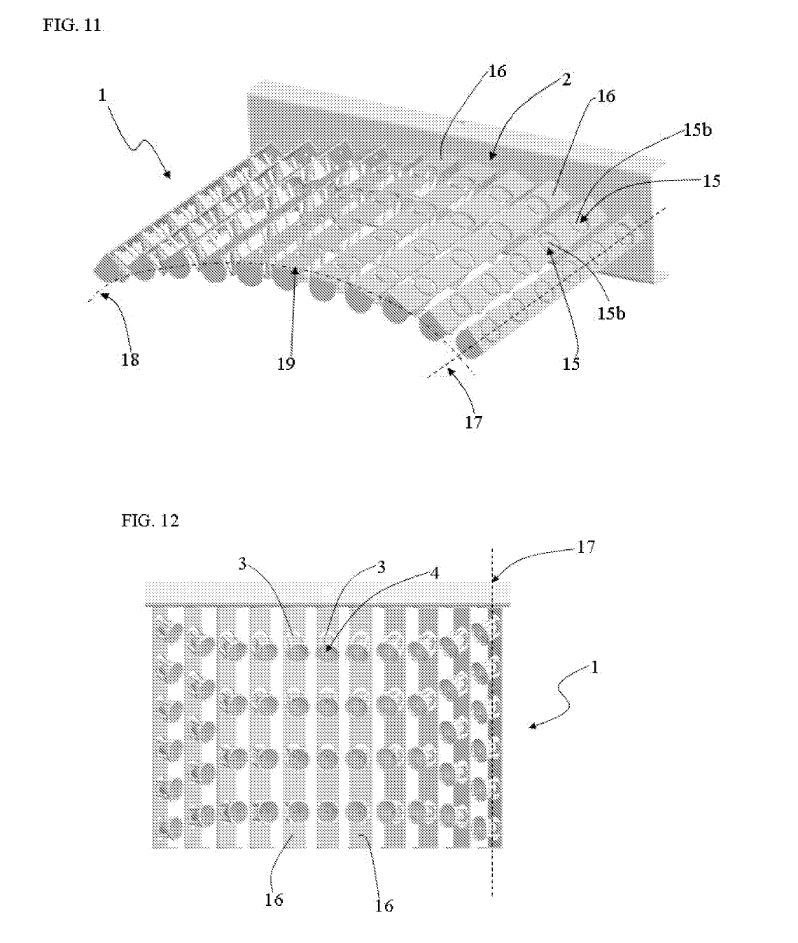

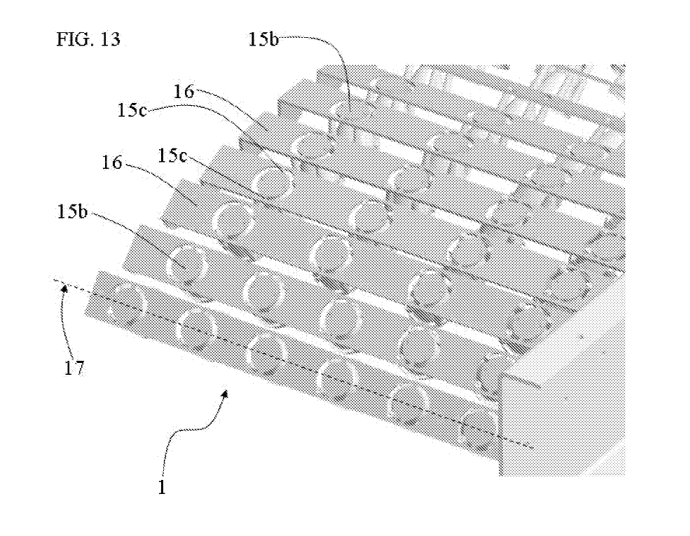

In a second embodiment, illustrated in FIGS. 11, 12 and 13, the support surface 2 is constituted by plates 16 extended in a longitudinal direction 17. Said plates are approached to each other according to the longitudinal direction 17. Preferably, said plates 16 are positioned in such a way as to have mutually parallel longitudinal axes. Said plates 16 are preferably approached in such a way as to define a curved profile 18 with concavity 19 substantially tangentially to the predefined plane 6. In this way, each light source 3 is inclined relative to the predefined plane 6 in a first direction of inclination parallel to the longitudinal direction 17. Also in this second embodiment, the device 1 is further provided with supports 15 for each of the light sources 3. Said supports 15 are obtained on the plates 16 in such a way that the convergence points of the collimated light beams 5 are opposite to the predefined plane 6 relative to the plates 16 themselves.

Preferably, in this second embodiment, each support 15 comprises a discoidal element 15b, directly obtained on the corresponding plates 16, and junction elements 15c to connect the discoidal element 15b to the plate 16. Preferably, each support 15 comprises two junction elements 15c diametrically opposite relative to the discoidal element 15b. In particular, each light source 3, being mounted on the corresponding discoidal element 15b, is inclined relative to the predefined plane 6 in a second direction of inclination different from the first direction of inclination. Each light source 3 is therefore inclined relative to the predefined plane 6 according to two directions of inclination.

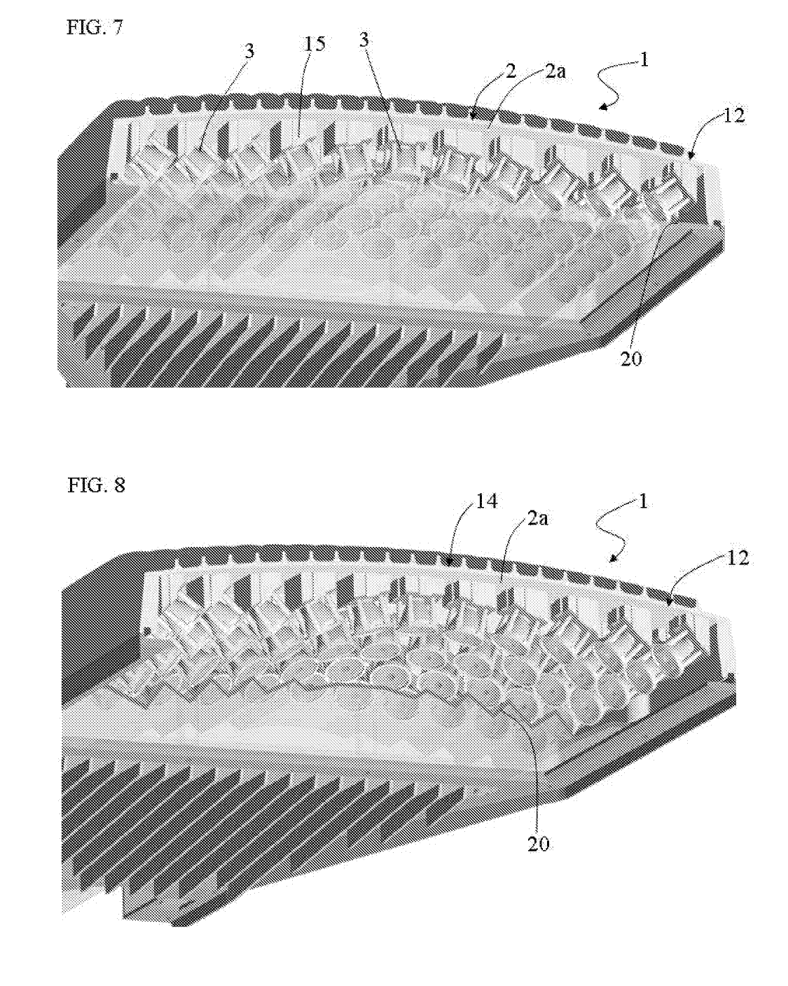

Advantageously, the device 1 is provided with a filter 20 positioned to cover the light sources 3. Preferably, said filter 20 is the same only one for all the light sources 3. Preferably, the filter 20 is a distributor filter that mixes uniformly the collimated light beams 5. The filter 20 is preferably made with materials having refraction indexes between 1.3 and 1.9. FIG. 7 shows the filter 20 in a planar configuration.

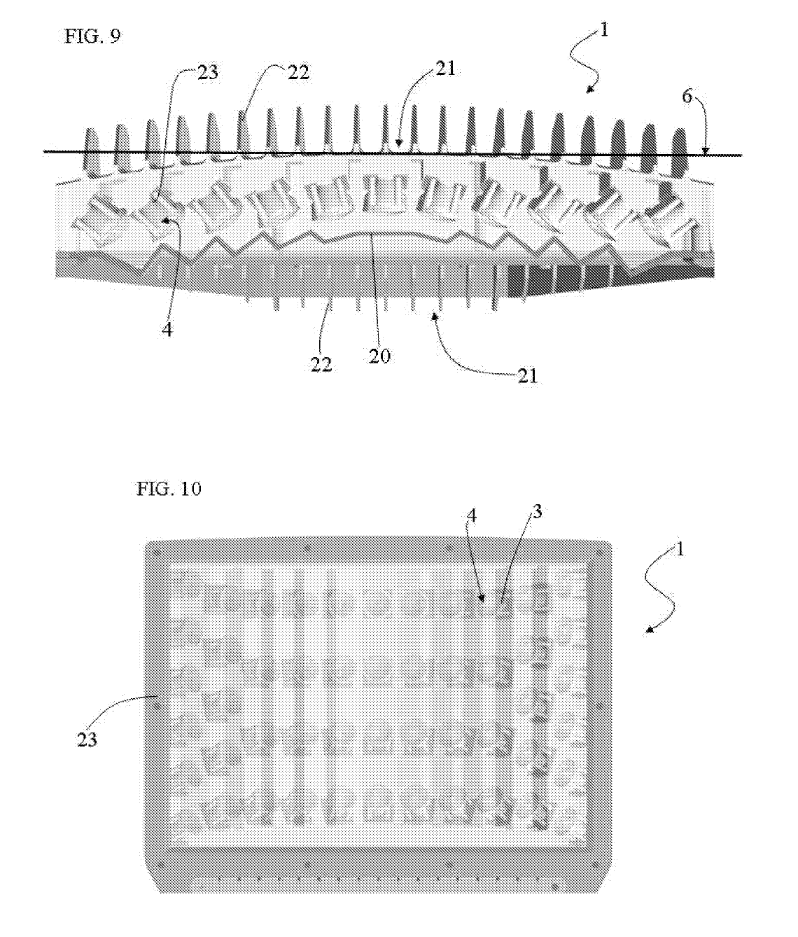

Originally, the filter 20 is faceted (see FIGS. 8 and 9) in such a way that the collimated light beams 5 strike the filter 20 and are transmitted in a substantially total manner. Indeed, the faces of the filter 20 are oriented relative to the collimated light beams 5 that traverse them in such a way as to form such angles of incidence that there is a substantially total transmission of the light radiation. Preferably, on the filter 20 is performed an anti-reflex treatment aimed at increasing the total efficiency of the device 1 by up to 8%.

Advantageously, the device 1 is provided with a dissipator 21 to disperse the heat generated by the light sources 3. Indeed, the junction temperature of the LED light sources 3 must be kept below the aforesaid cold junction temperature for reliability reasons. Preferably, the dissipator 21 has dissipation fins 22.

Originally, the angles formed by the light sources 3 relative to the predefined plane 6 are modifiable in such a way as to vary the distance of the convergence points relative to the predefined plane 6. In this way, the distance of the convergence area 9 relative to the predefined plane 6 is varied.

Preferably, the device 1 comprises a control circuit of the light sources 3. Said control circuit is subdivided into a plurality of modules able to drive the lighting of groups of light sources 3. In particular, each module of the control circuit drives the lighting of a group of light sources 3 in such a way that, in case of failure of said module, the remaining modules (driving other groups of light sources 3) continue to work correctly, allowing an illumination, albeit partial.

The support surface 2, the light sources 3, the optical elements 4, the filter 20, the dissipator 21 and the supports 15 are part of a lighting body 23 of the device 1. The device 1 is preferably provided with a support post 24 of the lighting body 23 to position said lighting body 23 at a determined height relative to the area to be illuminated.

The operation of the LED lighting device, according to the present invention, is substantially as follows.

The light beams emitted by the LED light sources 3 are collimated by the optical element 4 in such a way as to obtain the collimated light beams 5 that strike the filter 20. In the passage through the filter 20, the collimated light beams 5 are transmitted in a substantially total manner and are mixed in a light cone 25 to illuminate a predetermined area.

In particular, the lighting body 23 of the device 1, positioned at a height of 8 metres from the ground, can illuminate a surface with dimensions 29 metres×8 metres.

From the above description, the characteristics of the LED lighting device according to the present invention are clear, as are its advantages. In particular, it is possible to illuminate surfaces positioned at different distances from the device modifying the angles of inclination of the light sources relative to the predefined plane.

Moreover, the illumination obtained is homogeneous and uniform thanks to the use of the filter that mixes the collimated light beams.

Lastly, the proposed device has high efficiency (above 80%) because light dispersion is limited both by the use of the collimator optical elements and by the faceted profile of the filter as well as by the anti-reflex treatment of the filter itself.

1. LED lighting device (1) comprising:
a support surface (2) constituted by a portion (12) of a semi-cylindrical cladding positioned in such a way as to have concavity (14) of the portion (12) that is substantially tangential to a predefined plane (6);
a plurality of LED light sources (3) positioned on the support surface (2);
a plurality of optical elements (4) associated with said light sources (3) and coaxial thereto to generate collimated light beams (5) for covering a defined space to be illuminated, said light sources (3) being individually inclined relative to said predefined plane (6) to form angles, also different, in such a way that collimated light beams (5) intersect defining convergence volumes;
supports (15) for each of the light sources (3), said supports (15) being mounted internally to said portion (12) of the semi-cylindrical cladding in such a way that the convergence volumes are opposite to the predefined plane (6) relative to said portion (12), each support (15) being provided with a base (15a) whereon is mounted the corresponding light source (3), characterised in that all the bases (15a) have the same superficial extension but different inclination relative to the predefined plane (6).

2. Device (1) as claimed in claim 1 characterised in that the convergence volumes of the collimated light beams (5) identify a smaller convergence area (9) than the area (10) delimited by the light sources (3) on the support surface (2).

3. Device (1) as claimed in claim 1 characterised in that the convergence volumes of the collimated light beams (5) define a convergence plane that is substantially parallel to the predefined plane (6).

4. Device (1) as claimed in claim 1 characterised in that each optical element (4) is associated to one of the light sources (3) in such a way that the related collimated light beam (5) intersects at least another one of said collimated light beams (5).

5. Device (1) as claimed in claim 1 characterised in that it further comprises a filter (20) positioned to cover the light sources (3) to mix uniformly the collimated light beams (5).

6. Device (1) as claimed in claim 5 characterised in that the filter (20) is faceted to transmit in a substantially total manner the collimated light beams (5) that strike the filter (20) itself.

7. Device (1) as claimed in claim 1 characterised in that it further comprises a dissipator (21) to disperse the heat generated by the light sources (3).

8. Device (1) as claimed in claim 1 characterised in that the angles formed by the light sources (3) relative to the predefined plane (6) are modifiable such as to vary the distance of the convergence volumes relative to the predefined plane (6).

9. Device (1) as claimed in claim 1 characterised in that it further comprises a control circuit of the light sources (3), said control circuit being subdivided into a plurality of modules able to drive the lighting of groups of said light sources (3).

10. Device (1) as claimed in claim 1, characterised in that each light source (3) is inclined according to two directions relative to the predefined plane (6).

11. Device (1) as claimed in claim 1, characterised in that each light source (3) is inclined relative to the predefined plane (6) in a first direction of inclination parallel to the longitudinal extension of said portion (12) of the semi-cylindrical cladding.

12. Device (1) as claimed in claim 11, characterised in that each source (3), being mounted on the corresponding support (15), is inclined relative to the predefined plane (6) in a second direction of inclination different from said first direction of inclination.

13. Device (1) as claimed in claim 1 characterised in that the support surface (2) is constituted by plates (16) extended in a longitudinal direction (17) and approached according to said longitudinal direction (17) in such a way as to define a curved profile (18) with concavity (19) substantially tangential to the predefined plane (6).

14. Device (1) as claimed in claim 13 characterised in that said supports (15) are obtained on the plates (16) in such a way that the convergence volumes are opposite to the predefined plane (6) relative to said plates (16).
